(19) United States
(12) Patent Application Publication
(10) Pub. No.: US 2022/0089054 A1
(43) Pub. Date: Mar. 24, 2022

(54) ESTIMATION OF CHARGING DURATION FOR ELECTRIC VEHICLES

(71) Applicant: Cummins Inc., Columbus, IN (US)

(72) Inventors: Omkar A. Harshe, Columbus, IN (US); Pramod S. Magadi, Indianapolis, IN (US); Joseph E. Paquette, Columbus, IN (US)

(21) Appl. No.: 17/356,101

(22) Filed: Jun. 23, 2021

Related U.S. Application Data
(60) Provisional application No. 63/080,394, filed on Sep. 18, 2020.

(51) Int. Cl. B60L 53/62; H02J 7/00; B60L 58/12

(52) U.S. Cl. CPC B60L 53/62; H02J 7/0048; B60L 2240/80; B60L 58/12; H02J 2310/48; H02J 7/007182

(57) ABSTRACT

A method to estimate a time to full charge of battery packs of an electric vehicle, including: determining a predetermined transition voltage based on a charging capacity of a charger; estimating a voltage of a battery pack; determining a constant charging-current phase duration, a transition from the constant charging-current phase duration to a tapered charging-current phase occurring when the estimated voltage equals the predetermined transition voltage, the constant charging-current phase duration being based on the transition to the tapered charging-current phase; determining a tapered charging-current phase duration; and adding the constant charging-current phase duration to the tapered charging-current phase duration to determine a charging time.

### CROSS-REFERENCE TO RELATED APPLICATIONS

The present application claims priority from and the benefit of U.S. patent application No. 63/080,394 entitled “METHOD TO ESTIMATE TIME TO FULL CHARGE OF A BATTERY OF AN ELECTRIC VEHICLE,” filed Sep. 11, 2020, which is incorporated herein by reference in its entirety.

### TECHNICAL FIELD

The present disclosure relates to devices and methods to charge batteries.

### BACKGROUND

It is desirable to charge batteries of electric vehicles fast with a charger by providing the maximum amount of power the batteries can safely receive. The electric vehicles may include accessories and the accessories may be powered by the batteries on an electric high voltage bus, or bus, or the battery charger when connected to the bus.

Calculating the time required to charge the batteries of an electric vehicle to a desired setpoint is, presently, difficult or impossible to do accurately, but it is important. Electric vehicles may include, for example, buses. Electric buses operate on routes and the battery charge level may be used to determine which route a bus can complete given its present charge. The time required to charge a bus may be used to determine when to bring the bus to charge or out into circulation and which route to assign to the bus. The logistics of a transportation system comprising electric vehicles would improve if the time to full charge of the batteries of the electric vehicles could be determined more accurately than presently possible.

Additionally, chargers from different manufacturers may have different capabilities, some manufacturers providing chargers with higher capacity than others, for example ranging between 78 and 200 amperes. Transit authorities employing a mix of chargers and buses would be able to improve logistics and utilization of the buses if time to charge estimates were improved by accounting for such differences.

Accordingly, new methods are desirable to improve the estimation of charging times of electric vehicles.

### SUMMARY

In aspects of the disclosure an electric vehicle having a battery and a powertrain controller, a powertrain controller, and a method of estimating the charging time of the battery by the powertrain controller, are provided.

The disclose embodiments improve logistics and utilization of the electric vehicles by providing a more accurate time to full charge than presently available.

In a first aspect, a method to estimate a time to full charge of battery packs of an electric vehicle is provided. In one embodiment, the method comprises: determining a predetermined transition voltage based on a charging capacity of a charger; estimating a voltage of a battery pack; determining a constant charging-current phase duration, a transition from the constant charging-current phase duration to a tapered charging-current phase occurring when the estimated voltage equals the predetermined transition voltage, the constant charging-current phase duration being based on the transition to the tapered charging-current phase; determining a tapered charging-current phase duration; and adding the constant charging-current phase duration to the tapered charging-current phase duration to determine a charging time.

In a second aspect, a powertrain controller to control charging of battery packs of an electric vehicle having an electric powertrain powered by the battery packs is provided. In some embodiments, the powertrain controller comprises charging logic operable to: determine a predetermined transition voltage based on a charging capacity of a charger; estimate a voltage of a battery pack; determine a constant charging-current phase duration, a transition from the constant charging-current phase duration to a tapered charging-current phase occurring when the estimated voltage equals the predetermined transition voltage, the constant charging-current phase duration being based on the transition to the tapered charging-current phase; determine a tapered charging-current phase duration; and add the constant charging-current phase duration to the tapered charging-current phase duration to determine a charging time.

In a third aspect, an electric vehicle is provided. In some embodiments, the electric vehicle comprises: an electric powertrain; battery packs connected to power the electric powertrain; and a powertrain controller comprising charging logic operable to: determine a predetermined transition voltage based on a charging capacity of a charger; estimate a voltage of a battery pack; determine a constant charging-current phase duration, a transition from the constant charging-current phase duration to a tapered charging-current phase occurring when the estimated voltage equals the predetermined transition voltage, the constant charging-current phase duration being based on the transition to the tapered charging-current phase; determine a tapered charging-current phase duration; and add the constant charging-current phase duration to the tapered charging-current phase duration to determine a charging time.

### BRIEF DESCRIPTION OF DRAWINGS

The above-mentioned embodiments and additional variations, features and advantages thereof will be further elucidated by the following illustrative and nonlimiting detailed description of embodiments disclosed herein with reference to the appended drawings, wherein:

FIG. 1 is a schematic diagram of a vehicle electrically connected to a charger;

FIG. 2 is a graph depicting an example of a charging current and a resulting voltage;

FIG. 3 depicts a comparison of charging powers for various chargers of different sizes;

FIG. 4 depicts a graph depicting a charging power relationship to voltage; and

FIG. 5 is a block diagram of an embodiment of battery charge logic.

In the drawings, corresponding reference characters indicate corresponding parts, functions, and features throughout the several views. The drawings are not necessarily to scale and certain features may be exaggerated in order to better illustrate and explain the disclosed embodiments.

### DESCRIPTION OF EMBODIMENTS

For the purposes of promoting an understanding of the principles of the disclosure, reference will now be made to the embodiments illustrated in the drawings, which are described below. The embodiments disclosed below are not intended to be exhaustive or limit the disclosure to the precise form disclosed in the following detailed description.

Different scenarios are possible during charging of a battery of an electric vehicle. As used herein, an electric vehicle comprises a vehicle with an electric powertrain. Generally, an electric powertrain comprises electric motors connected, directly or indirectly, to a traction system. A traction system may comprise wheels, for example. The wheels may drive continuous treads, or tracks, for example. The powertrain may be entirely electric, e.g. an all-electric vehicle, or may include, in addition to the electric motors, a combustion engine, e.g. a hybrid electric vehicle. Thus, as used herein, hybrid and all-electric vehicles are types of electric vehicles. The charging current may be limited by the electric vehicle supply equipment (EVSE). The EVSE may comprise a charger, charger cable, a connector of the charger cable, etc. The charging current may also be limited by the battery. In the case where charging is limited by the battery, charging may be affected during cold warm-up, start of charging, pack integration, under/over delivery by the EVSE, and accessory reporting inaccuracies. Logic described below addresses these scenarios.

Additional factors can make the estimation of charge time challenging. The power acceptance capability of the battery, for example, may vary with temperature, voltage, and battery health. Protections may be enforced as a function of voltage or state-of-charge. Accessory loads may run during charging and may affect the amount of current provided to the battery given the maximum current delivery capability of the particular charger coupled to the vehicle. Some of the accessories may be reporting accessories while others might be non-reporting accessories; thus, there may be an information gap concerning the accessory power consumption during charging. In a distributed battery system, pack-to-pack imbalance may exist which impacts charging duration. Finally, smart charge management enables configuration of the current capability of the charger during charging, and the configuration also affects the time to charge.

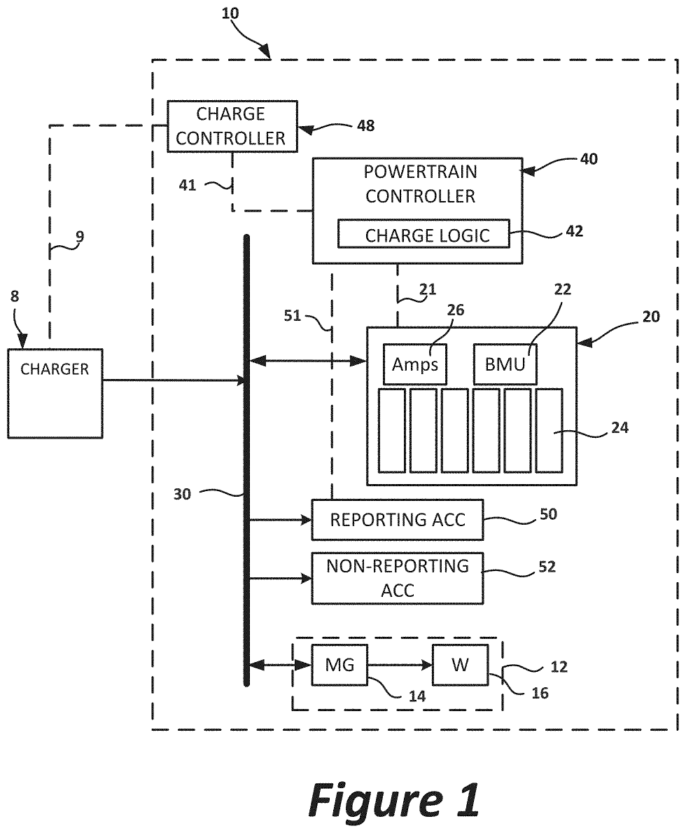

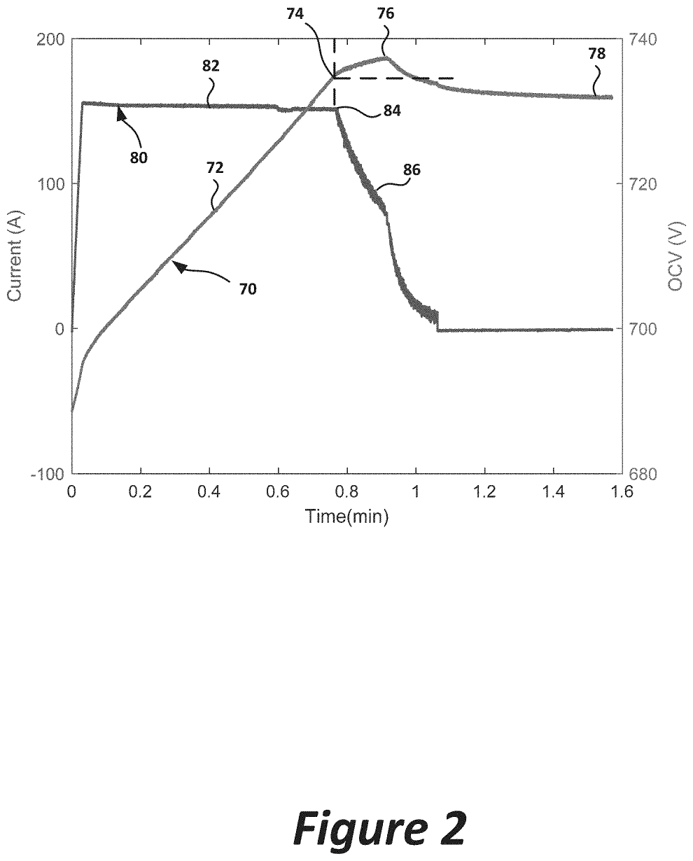

Components of an example electric vehicle are described below with reference to FIG. 1. The components of the electric vehicle described with reference to FIG. 1 may be mentioned in connection with the description of an embodiment of a method to estimate time to charge, which is described with reference to FIG. 2.

FIG. 1 is a schematic diagram of a vehicle 10 electrically connected to a charger 8. Electric vehicle 10 comprises: an electric traction system 12 including a motor-generator 14 and wheels 16 which may be connected to motor-generator 14 by an axle (not shown) or directly; a battery 20 connected to a bus 30 to power electric traction system 12; and a powertrain controller 40 to control charging of battery 20 when bus 30 is connected to charger 8. A charge controller 48 establishes communications, as is known in the art, between the powertrain controller and the charger. The charge controller receives a charge command from the powertrain controller and provides it to the charger. The charge controller may monitor sensor signals and perform safety and performance checks and determine faults based thereon. For example, the charge controller may determine a fault if charging started but a physical connection between the charger and the vehicle fails to be detected or is detected to be outside safe boundaries. Thus, the charge controller functions as the communication interface between the charger and the powertrain controller.

A reporting accessory 50 and a non-reporting accessory 52 are also shown, drawing power from bus 30. Communication lines 9, 21, 41, and 51 enable powertrain controller 40 to communicate with charger 9, battery 20, and reporting accessory 50, respectively. Preferably the communication lines convey digital data between the components. A CAN bus may be implemented to provide the communication lines. In a preferred embodiment a first CAN bus may be implemented to provide communication lines 21 and 51 and a second CAN bus may be implemented to provide communication line 41. Any serial or parallel communication scheme and protocol know in the art may be used to provide communication line 9.

As the name implies, reporting accessory 50 is operable to communicate information to powertrain controller 40. Such information may include identification, current demand, high or low voltage power draw, and other information. The identification information may convey a maximum current capacity of the accessory, for example. The current demand may be dynamic, such that the current demanded by reporting accessory 50 fluctuates. Reporting accessory 50 may be an air conditioning system, for example, and the current demand may vary based on a temperature of the vehicle compared to a target temperature. By reporting current demand to powertrain controller 40, reporting accessory 50 enables powertrain controller 40 to more accurately determine the target current to generate the charge command to the charger. On the other hand, the load of a non-reporting accessory may be dynamic and unknown, resulting in the charger underdelivering current to the battery thus reducing the charging time from a faster charging time that results by the implementation, as discussed herein, of a feedback control. The charge command may also take into account the charger's capability to deliver the current. The charge command indicates to the charger what level of current to output to the vehicle, which should be sufficient to optimally charge the battery and also power the accessories.

Battery 20 may comprise one or more battery packs comprising a battery management unit (BMU) 22 and battery modules 24. BMUs are generally well known. Temperature, voltage, and other sensors may be provided to enable BMU 22 to manage the charging and discharging of battery modules 24 without exceeding their limits, to detect and manage faults, and to perform other known functions. Battery 20 has a battery charge power limit that should not be exceeded. The bus voltage may be referred to as the system voltage. Via the communication line BMU 22 may convey to powertrain controller 40 information about the battery, including the battery charge power limit, temperature, faults, etc. Battery 20 may include a current sensor 26 to provide a measured current value to the BMU. The measured current value is used by the feedback control to affect the charge command provided to the charger. The current sensor may also be located elsewhere. Multiple current sensors may also be provided, each associated with a battery module of the battery, the sum of the measured currents being the measured current of the battery.

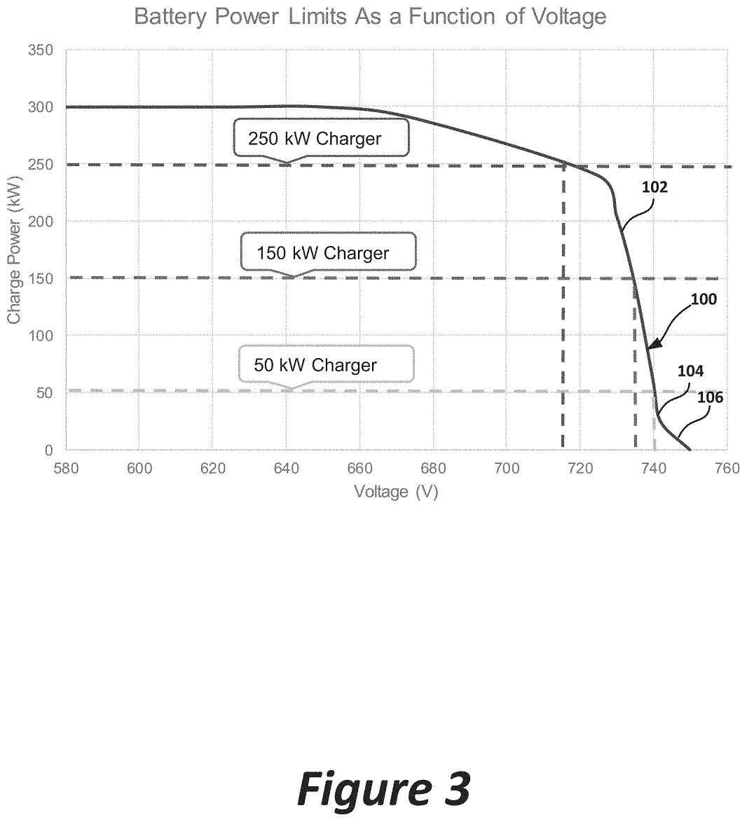

Powertrain controller 40 comprises charge logic 42 operable to determine a command for the charger to supply target current to the battery, as described below with reference to FIGS. 2 and 3. Charge logic 42 may also be integrated with a controller of BMU 22 or provided in a stand-alone controller communicatively coupled to powertrain controller 40. The term “logic” as used herein includes software and/or firmware comprising processing instructions executing on one or more programmable processors, application-specific integrated circuits, field-programmable gate arrays, digital signal processors, hardwired logic, or combinations thereof, which may referred to as “controllers”. Therefore, in accordance with the embodiments, various logic may be implemented in any appropriate fashion and would remain in accordance with the embodiments herein disclosed. A non-transitory machine-readable medium comprising logic can additionally be considered to be embodied within any tangible form of a computer-readable carrier, such as solid-state memory, containing an appropriate set of computer instructions and data structures that would cause a processor to carry out the techniques described herein. A non-transitory computer-readable medium, or memory, may include random access memory (RAM), read-only memory (ROM), erasable programmable read-only memory (e.g., EPROM, EEPROM, or Flash memory), or any other tangible medium capable of storing information.

Powertrain controller 40 may include functionality well known in the art of electric vehicles. Such functionality may include logic to control the motor-generator by determining a desirable torque and commanding the battery to provide power commensurate with said toque, and may include functionality for range-extension, regeneration, torque ratio control if a combustion engine is provided in an hybrid electric vehicle, etc. Powertrain controller 40 may also control all the high voltage accessories coupled to the bus. The high voltage bus may have a voltage greater than 500 volts DC, potentially in a range of 550-850 volts DC.

Powertrain controller 40 may include functionality well known in the art of electric vehicles. Such functionality may include logic to control the motor-generator by determining a desirable torque and commanding the battery to provide power commensurate with said toque, and may include functionality for range-extension, regeneration, torque ratio control if a combustion engine is provided in an hybrid electric vehicle, etc.

A transport control system and charging management system may communicatively connect multiple chargers and control charging processes in a depot, linking charging points, power supplies, and operational information systems, such as planning and scheduling systems. The transport control system may provide the charging management system information such as estimated arrival time of vehicles, time available for charging, and scheduled pull-out time. The charging management system can then calculate the charging requirements for each vehicle and optimize charging processes for the fleet of vehicles to, for example, avoid as much as possible expensive grid peak load periods. The charging management system can assign time slots for charging to each vehicle and monitor progress. The charging management system may receive from the vehicle an estimated time to full charge. The determination of the time to full charge is described further below. In an alternative embodiment, the vehicle may provide the relevant data to the charging management system and the charging management system may estimate the time to full charge within its control logic.

An embodiment of a method for calculating charging duration will now be described. Variations, refinements and improvement on the present embodiment are described further below. In the present embodiment battery packs with 50% state-of-charge (SOC) and 90 AMP-HR usable capacity are charged to 100% SOC. The charger has a 78 AMP capacity and there are six battery packs. The charging duration is thus calculated by dividing a numerator equal to the product of (1) number of packs, (2) 100—starting SOC, and (3) AMP-HR usable capacity, by a denominator equal to the product of (4) charge capacity and (5) 100, and adding the pack balancing duration, in this case 0.33 hr. The charging capacity is thus [6*(100−50)*90]/[70*100]+0.33 or 4.187 hrs. As is well known, pack balancing is a process during which packs with low voltage are charged by packs with large voltages until all the packs have voltages within a predetermined range. The BMU opens and closes contactors and measures voltages of the packs to determine how to interconnect the various packs to achieve the desired balancing. The pack balancing time can be an predetermined estimate based on various factors including the number of battery packs in the vehicle.

In a variation of the foregoing embodiment, the charging duration estimate is improved by accounting for the power drawn by accessories when the accessory load limits the amount of power the charger can provide the batteries. The accessory load may be reported by a reporting accessory or estimated by comparing the amount of current the batteries may receive and the current they actually receive.

In a further variation of the foregoing embodiment, the charging duration estimate is improved by accounting for integration opportunities. A pack integration duration may be a predetermined or calibratable value. The charging duration estimate is improved by adding the product of the pack integration duration and the number of integration opportunities.

FIG. 2 is a graph illustrating the effect of charging current on battery voltage. A voltage curve 70 and a current curve 80 are shown. Current curve 80 includes a substantially constant current section 82, a transition point 84, and a current taper section 84. Voltage curve 70 includes a ramp-up section 72, a predetermined voltage 74, and a voltage overshoot section 76. Transition point 84 corresponds to predetermined voltage 74. When the voltage reaches the predetermined voltage level associated with predetermined voltage 74, the charger transitions from charging a constant current to tapering the current, at which time the voltage settles to a desired or target voltage level 78. Knowledge about the slope and other characteristics of ramp-up section 72 can be used to estimate the time duration of constant current section 82 and current taper section 84, thus the charging time of the batteries exclusive of integration and balancing time.

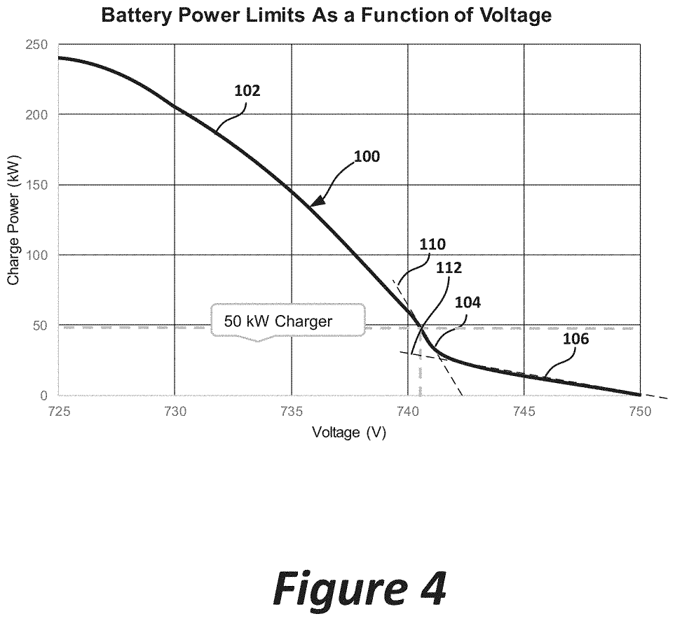

FIG. 3 illustrates the effect of the capability of the charger on voltage with a curve 100 depicting a relationship between the charge power and the battery voltage. Curve 100 has a first section 102, a second section 104, and a third section 106. Sections 104 and 106 are described in more detail with reference to FIG. 4 As shown, chargers with 50, 150, and 250 kW capability intersect the shown power curve at predetermined voltages, about 718 volts, 738 volts, and 740 volts, that trigger the switch from constant current to taper current. Thus, the charger capability can be used to determine the duration of the constant current and taper current sections of the charging curve for the particular charger. An offset can be applied to calculate the open-load voltage of the battery in view of the overshoot, which is a function of the C-rate of the battery. The C-rate is calculated based on the charger current and the number of online packs, e.g. current/pack. The SOC is proportional to the open-load voltage, and, therefore, the SOC at the end of the constant current section, or phase, can be estimated. This SOC may be referred to as the “bulk SOC” and time to charge to bulk SOC is reported as “time to bulk charge”.

Look-up tables can be used to estimate voltages during charging using a charging curve, as shown in FIG. 2, that includes a constant charging current section and a tapered charging current section. Depending on the capability of the charger and number of packs charging, constant current and tapered current duration will change. The BMU can determine when to taper by comparing the estimated voltage with the the voltage from the look-up table, which is based on the charge power and the charger, as described above.

Based on the foregoing, the time to complete the constant current phase, or time to bulk charge, can be calculated as [(bulk SOC minus the initial SOC)*capacity*number of packs]/[maximum charger current]. The time to complete the taper current phase is based on the difference between bulk SOC and 100%, which is the remaining capacity to be filled during the current taper phase. This remaining capacity is estimated as [(100−bulk SOC)*capacity*number of packs]/[100]. The time to fill this capacity can be estimated in different ways using the charge power curve. Curve characteristics are used, e.g. changes in slope indicative of a significant change, to define “buckets” in which the charge power is consistent, calculating the time in each bucket, and summing the times. An example is shown in FIG. 4.

FIG. 4 illustrates the curve 100 of FIG. 3, depicting a relationship between the charge power and the battery voltage. For a 50 Kw charger, at about 741 V the battery is close to the charging limit and the slope of the charge power changes as the charger ends constant current operation and transitions to taper operation. Second section 104 and third section 106, each defining a “bucket”, can be approximated by straight lines 110 and 112, each having a slope. The voltage change corresponding to second section 104 represents a first amount of time, and the voltage change corresponding to third section 106 represents a second amount of time, the first and second amounts corresponding to the remaining charging time. The charging capacity is well defined for a given voltage range. In the example illustrated with reference to FIG. 4, a battery voltage range of 580-750 V corresponds to the 0-100% SOC range and 600 AMP-HR, thus each 1% of SOC represents 1.7 V and 6 AMP-HR change. Thus, based on the voltage of each bucket and the charging capacity, the current draw is determined and the time at the given current draw to fill the particular bucket is determined. The charging capacity of the charger may be derated to account for loads being contemporaneously supplied by the charger. The demand from the loads may vary and thus the charging capacity derating may be performed periodically.

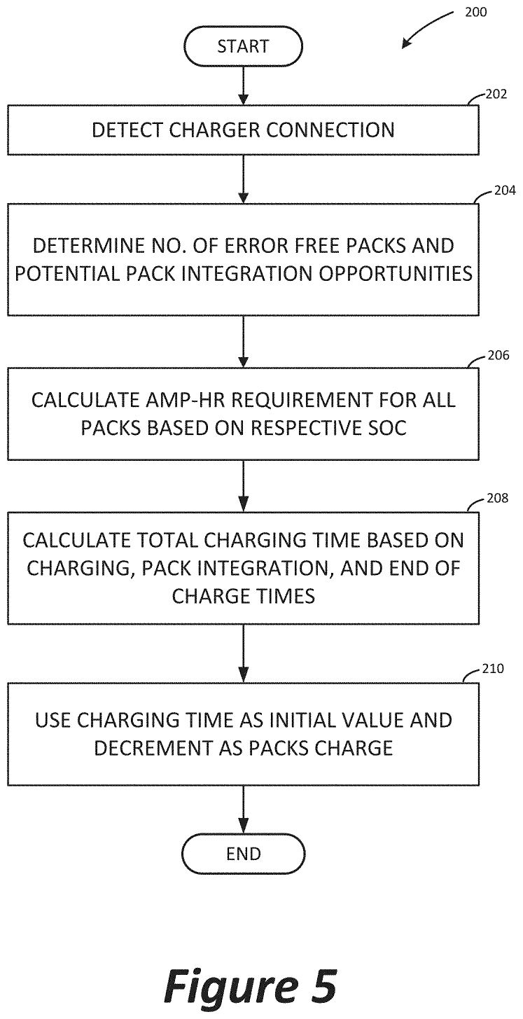

Referring now to FIG. 5, another embodiment of a method to estimate time to full charge of a battery of an electric vehicle will be described with reference to a flowchart 200. The method begins when a charger connection is detected, at 202. The connection may be detected by charge controller 48 based on sensors associated with the connection of a plug/receptacle combination and detected by charge controller 48 or communicated by charger 9 via communication line 9. Sensors may include contact switches, proximity switches, inductive sensors, optical or thermal sensors, and the like.

At 204, the number of error free packs and potential pack integration opportunities are determined. The vehicle may comprise many batteries, or battery packs, distributed within the vehicle, for example on the roof or within the frame below the floor. Battery packs may become defective or they may temporarily overheat and be disconnected. These are batteries with errors. Other errors are possible. The remaining batteries may be error free and either online or offline. Online error free batteries may power the vehicle while offline batteries may be offline (disconnected from the high voltage bus) for any number of reasons such us, for example, a battery error that cleared and is no longer present. The batteries with errors and error free disconnected batteries might be completely discharged or retain a higher or lower charge than the online batteries. The battery charge imbalance among the many batteries requires care in how the batteries are connected and disconnected for charging and this affects the time to charge. The number of error free packs is determined by counting error free packs or subtracting packs with errors from a total number of packs in the vehicle.

To determine the number of pack integration opportunities, the SOC of the error free offline batteries are compared. Batteries/packs with similar SOC can be integrated, e.g. charged at the same time. Similarity of SOC may be determined if the SOC is within an SOC range that may be calibrated. For example, batteries within a 5% SOC range may be considered to have similar SOC. Thus, batteries with 50%, 53% and 55% SOC present an integration opportunity that excludes a battery with 48% or 58% SOC. The number of integration opportunities is the number of “groups” of batteries within the SOC range. The average SOC for each group will vary. One group/opportunity may include batteries within a 50-55% SOC range while another group/opportunity may include batteries within a 30-35% SOC range, in each case the SOC range is the same, 5%, but the average of one group is 20% lower than the other group. Optionally, the SOC range may vary with the SOC. Thus, if the SOC is higher the range might be narrower while if the SOC is lower the range might be wider to allow for more batteries in the group with lower SOC. This may be possible because problems arising from voltage imbalances tend to be greater with greater voltages. Voltage ranges may vary as function of SOC for other reasons. Determining number of potential integration opportunities is important as during each integration event, charging current is dropped to almost zero in order to bring packs online. This, although important from vehicle operation, results in longer charging duration. Accounting for it will increase estimation efficiency and accuracy.

At 206, the AMP-HR requirement for all batteries is calculated. The AMP-HR requirement is an indication of battery's usable capacity. For instance, a battery may have a 100 AMP-HR capacity of which 80% is usable, thus the battery has 80 AMP-HR usable capacity. Charging the battery to 100% SOC will give the battery 80 AMP-HR capacity. The usable capacity may based on the state-of-health (SOH) of the battery. Based on the state of charge and state of health of each pack, the battery's charge acceptance capacity is calculated. This is done in the powertrain controller at the start of charging. The powertrain controller will check the capacity of all the online packs to determine the total charge current acceptance capability of the online packs. The powertrain controller may include charging logic to manage charging of the batteries and estimate the charging time. The powertrain controller may comprise one or more communicatively coupled physical controllers. With this information and the current the charger is capable of delivering the time time to full charge can be determined for the online packs, as described above with reference to FIGS. 3 and 4. Then pack integration time is added as necessary to bring the same number of packs online and assume that the current acceptance capability of the battery post integration will be equal to or better than the current accepting capability of the battery(ies) before integration. If the battery current acceptance is greater than the charger can deliver, adding additional packs will have no impact. If the battery current acceptance capability is less than the charger can deliver, after integrating packs, battery current acceptance can go up. The charging time will then be decreased to account for the increased current that the charger can deliver and the batteries can accept post integration.

The charging duration for the battery can then be calculated as {(100−SOC)*[AMP−HR]}/{ Charge capability*100} +[pack balancing duration]. The charge capability may be the minimum of (a) the current flow the battery can receive and (b) the capacity of the charger to provide current, accounting for current provided by the charger to accessories connected to the high voltage bus and commanded to operate while the charger is charging the battery. In other words, the battery or the charger may present a current limitation and charging at the limit will determine the charging time. The current drawn by accessories may be updated in real time. The accessories may be reporting accessories or, alternatively, current sensors may be added to monitor current flow to them.

At 208, the total charging time is calculated as the sum of the time to charge the batteries considering charging time, pack integration, and end-of-charge times, as described above with reference to FIGS. 2 and 3.

The pack integration charging time is the duration ascribed to pack integration events. Each integration opportunity corresponds to an integration event. A calibratable time is assigned to the integration opportunity and, thus, the pack integration charging time comprises the calibratable time times the number of integration opportunities. The calibratable time corresponds to actions that take place during the integration event. These actions may include sensing the voltage of a battery, opening and closing contactors, calculating the voltage differences from the high voltage bus voltage etc. and adjusting the current delivery to the online packs such that the voltage of packs to be integrated lines up with the online packs. As these actions repeat for a given integration scheme, the calibratable time, also referred to as integration event time, can be estimated and then empirically changed to more accurately reflect actual experience. How to determine the number of integration opportunities was described above. In one example, a low SOC battery is charged until its voltage reaches the voltage of a group of batteries. At that time the battery is integrated with the group and the group is charged until it reaches the voltage of another group, then the groups are integrated and the process repeats until all the batteries are fully charged.

Some embodiments of pack integration are described in commonly owned International Application No. PCT/US2019/058087 published as WO2020/086973 and incorporated herein by reference. As described in one embodiment therein, a battery pack A that has a substantially lower SOC and/or battery voltage as compared to the voltages and SOCs of other battery packs, e.g. battery pack B, is charged first. As the battery pack is charged, the SOC and the voltage of the battery pack A increase towards the SOC and voltage of the battery pack B. Once the battery pack's SOC and voltage are within a predetermined range of or substantially equal then battery pack B may be connected to the previously charging pack with an acceptable equalizing current, and both packs begin to charge until the battery packs reach the maximum voltage and SOC. Contactors are used to connect and disconnect batteries/battery packs from the high voltage bus. The contactors are controlled by powertrain controller 40, which may send signals to the contactors to bring the batteries online or take them offline for charging, testing their open-circuit voltages, or other reasons. Voltage sensors in the batteries detect the voltage and the BMU communicates a corresponding voltage value to powertrain controller 40. The absolute value of the voltages may be used to determine if a battery voltage is less than or equal to a dVmax value, and if it is the battery is connected to charge. If the absolute voltage of the difference is greater than dVmax, the battery is not connected.

In another embodiment, batteries are charged for a predetermined time and then the charge logic reevaluates the voltages and/or SOC of the batteries. Thus, a battery with a very low voltage may be charged for the predetermined time, resulting in another battery having the lowest voltage, for example, at which time during the reevaluation the battery with the lowest voltage is charged for the predetermined time, in this manner always raising the voltage of the lowest voltage battery for a predetermined time.

For example, if there are 50 batteries and 4 integration events, the time to charge the 50 batteries plus (integration event time*4) provides a rough estimate of the required time. The rough estimate is improved by adding the end-of-charge calibration, described below.

The end-of-charge time is the time provided to the battery for the purpose of the cell balancing. In a well balanced energy storage system, cell imbalance between the high cell voltage and low cell voltage, without any current flow, is less than 20 mV. Depending on the nature of imbalance at the start of charging before current flow starts to the pack, an estimation is made based on the nature of imbalance. A calibratable table, which is populated with imbalance voltage as input and balancing time as output, can be used to determine the balancing time based on the sensed imbalance. Typically the imbalance does not change significantly during a charging session and hence the estimate can be very accurate.

At 210, the total charging time is used as an initial value that is decreased as the batteries reach full charge. As described above, the decreased time may result from the batteries' capacity to receive current relative to the capacity of the charger to deliver current as integration progresses.

In one variation of the present embodiment, if the calculated charging time updated during a charging cycle increases, the initial charging time is maintained and not increased. The updated charging time may reflect high battery temperatures or problems with the charger.

The scope of the invention is to be limited by nothing other than the appended claims, in which reference to an element in the singular is not intended to mean “one and only one” unless explicitly so stated, but rather “one or more.”

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

The embodiments and examples described above may be further modified within the spirit and scope of this disclosure. This application covers any variations, uses, or adaptations of the invention within the scope of the claims.

What is claimed is:

1. A method to estimate a time to full charge of battery packs of an electric vehicle, the method comprising:
determining a predetermined transition voltage based on a charging capacity of a charger;
estimating a voltage of a battery pack;
determining a constant charging-current phase duration, a transition from the constant charging-current phase duration to a tapered charging-current phase occurring when the estimated voltage equals the predetermined transition voltage, the constant charging-current phase duration being based on the transition to the tapered charging-current phase;
determining a tapered charging-current phase duration; and
adding the constant charging-current phase duration to the tapered charging-current phase duration to determine a charging time.

2. The method of claim 1, further comprising adding an offset to the charging time, the offset provided to account for a voltage overshoot at the end of the constant charging-current phase.

3. The method of claim 1, wherein estimating a voltage of a battery pack comprises estimating voltages of battery packs including the battery pack, further comprising adding, to the charging time, an integration time and a voltage equalization time, to determine the time to full charge of the battery packs of the electric vehicle.

4. The method of claim 3, further comprising determining the integration time by determining a number of integration events and multiplying the number of integration events by an event integration time.

5. The method of claim 4, wherein the time to full charge further includes an offset provided to account for a voltage overshoot at the end of the constant charging-current phase.

6. The method of claim 4, further comprising derating the charging capacity of the charger by an amount corresponding to a load electrically coupled to the charger and being charged by the charger.

7. The method of claim 6, wherein derating the charging capacity of the charger is performed periodically to account for demand variations in the load being charged by the charger.

8. The method of claim 1, further comprising derating the charging capacity of the charger by an amount corresponding to a load electrically coupled to the charger and being charged by the charger.

9. The method of claim 1, further comprising determining the time to full charge of the electric vehicle and transmitting a signal comprising an indication of the time to full charge.

10. The method of claim 9, further comprising, by a controller of a charging control system operably coupled to the charger, receiving the signal comprising the indication of the time to full charge.

11. A powertrain controller to control charging of battery packs of an electric vehicle having an electric powertrain powered by the battery packs, the powertrain controller comprising charging logic operable to:
determine a predetermined transition voltage based on a charging capacity of a charger;
estimate a voltage of a battery pack;
determine a constant charging-current phase duration, a transition from the constant charging-current phase duration to a tapered charging-current phase occurring when the estimated voltage equals the predetermined transition voltage, the constant charging-current phase duration being based on the transition to the tapered charging-current phase;
determine a tapered charging-current phase duration; and
add the constant charging-current phase duration to the tapered charging-current phase duration to determine a charging time.

12. The powertrain controller of claim 11, wherein the charging logic is operable to add an offset to the charging time, the offset provided to account for a voltage overshoot at the end of the constant charging-current phase.

13. The powertrain controller of claim 11, wherein estimating a voltage of a battery pack comprises estimating voltages of battery packs including the battery pack, wherein the charging logic is operable to add, to the charging time, an integration time and a voltage equalization time, to determine the time to full charge of the battery packs of the electric vehicle.

14. The powertrain controller of claim 13, wherein the charging logic is operable to determine the integration time by determining a number of integration events and multiplying the number of integration events by an event integration time.

15. The powertrain controller of claim 14, wherein the time to full charge further includes an offset provided to account for a voltage overshoot at the end of the constant charging-current phase.

16. The powertrain controller of claim 11, wherein the charging logic is operable derate the charging capacity of the charger by an amount corresponding to a load electrically coupled to the charger and being charged by the charger.

17. The powertrain controller of claim 16, wherein the charging logic is operable periodically derate the charging capacity of the charger to account for demand variations in the load being charged by the charger.

18. An electric vehicle comprising: an electric powertrain; battery packs connected to power the electric powertrain; and a powertrain controller comprising charging logic operable to:
determine a predetermined transition voltage based on a charging capacity of a charger;
estimate a voltage of a battery pack;
determine a constant charging-current phase duration, a transition from the constant charging-current phase duration to a tapered charging-current phase occurring when the estimated voltage equals the predetermined transition voltage, the constant charging-current phase duration being based on the transition to the tapered charging-current phase;
determine a tapered charging-current phase duration; and
add the constant charging-current phase duration to the tapered charging-current phase duration to determine a charging time.

19. The electric vehicle of claim 18, wherein the charging logic is further operable to determine the time to full charge of the electric vehicle and transmit a signal comprising an indication of the time to full charge.

20. The electric vehicle of claim 18, wherein estimating a voltage of a battery pack comprises estimating voltages of battery packs including the battery pack, wherein the charging logic is operable to add, to the charging time, an integration time and a voltage equalization time, to determine the time to full charge of the battery packs of the electric vehicle.
